(19) United States
(12) Patent Application Publication
(10) Pub. No.: US 2025/0299885 A1
(43) Pub. Date: Sep. 25, 2025

(54) MULTILAYER CERAMIC ELECTRONIC COMPONENT

(71) Applicant: Murata Manufacturing Co., Ltd., Nagaokakyo-shi (JP)

(72) Inventor: Yasukazu KAJIHARA, Nagaokakyo-shi (JP)

(21) Appl. No.: 19/018,268

(22) Filed: Jan. 13, 2025

(30) Foreign Application Priority Data
Mar. 19, 2024 (JP) 2024-043772

(51) Int. Cl. H01G 4/30; H01G 4/232

(52) U.S. Cl. CPC H01G 4/30; H01G 4/2325

(57) ABSTRACT

A multilayer ceramic electronic component includes an end surface-side base electrode layer including an intermittent region in which an end surface-side base electrode layer is intermittently present at least in a region of an inner layer portion in a vicinity of a first outer layer portion and a region of the inner layer portion in a vicinity of a second outer layer portion, and in a region in which the end surface-side base electrode layer is interrupted, the end surface-side electrically conductive resin layer is in contact with a corresponding one of laminated ceramic layers and a corresponding one of end portions of laminated internal conductive layers.

### CROSS REFERENCE TO RELATED APPLICATIONS

This application claims the benefit of priority to Japanese Patent Application No. 2024-043772 filed on Mar. 19, 2024. The entire contents of this application are hereby incorporated herein by reference.

### BACKGROUND OF THE INVENTION

### 1. Field of the Invention

The present invention relates to multilayer ceramic electronic components.

### 2. Description of the Related Art

In recent years, multilayer ceramic capacitors as multilayer ceramic electronic components are required to be durable under severe environments such as bending stress due to thermal expansion, and a technique is known which adopts a thermosetting electrically conductive resin paste for external electrodes on the multilayer ceramic capacitor. Japanese Unexamined Patent Application Publication No. H11-162771 discloses this type of technology. Japanese Unexamined Patent Application Publication No. H11-162771 discloses a multilayer ceramic capacitor including external electrodes, each including a layer structure in which an electrode layer prepared by dipping an electrically conductive paste and firing the resulting electrode layer, an electrically conductive epoxy thermosetting resin layer, a nickel plated layer, and a tin-based layer are sequentially laminated.

### SUMMARY OF THE INVENTION

With the multilayer ceramic capacitor of Japanese Unexamined Patent Application Publication No. H11-162771, it is possible to reduce or prevent the occurrence of cracks in the multilayer body due to the stress relaxation due to the sacrificial breakdown and deformation of the resin layer. On the other hand, in a multilayer ceramic capacitor having such a resin layer, it is necessary to reduce the thickness of each of the external electrodes while maintaining the bonding property between the internal electrode layers and the external electrodes. For example, it is not advantageous to increase the dimension in the length direction of the multilayer ceramic capacitor due to the thickening of the external electrodes.

Example embodiments of the present invention provide multilayer ceramic electronic components that are each able to reduce the thickness of external electrodes, while maintaining the bonding property between internal conductive layers and the external electrodes.

An example embodiment of the present invention provides a multilayer ceramic electronic component that includes a multilayer body including a plurality of laminated ceramic layers and a plurality of laminated internal conductive layers, a first main surface and a second main surface opposed to each other in a height direction, a first lateral surface and a second lateral surface opposed to each other in a width direction orthogonal or substantially orthogonal to the height direction, and a first end surface and a second end surface opposed to each other in a length direction orthogonal or substantially orthogonal to the height direction and the width direction, a first external electrode on the first end surface, and a second external electrode on the second end surface. The multilayer body includes an inner layer portion including the plurality of laminated ceramic layers and the plurality of laminated internal conductive layers, and a first outer layer portion and a second outer layer portion sandwiching the inner layer portion in the height direction. The first external electrode and the second external electrode each includes an end surface-side base electrode layer, an end surface-side electrically conductive resin layer on the end surface-side base electrode layer, and an end surface-side plated layer on the end surface-side electrically conductive resin layer. The end surface-side base electrode layer includes an intermittent region in which the end surface-side base electrode layer is intermittently present at least in a region of the inner layer portion in a vicinity of the first outer layer portion and a region of the inner layer portion in a vicinity of the second outer layer portion. In a region in which the end surface-side base electrode layer is interrupted, the end surface-side electrically conductive resin layer is in contact with a corresponding one of the plurality of laminated ceramic layers and a corresponding one of end portions of the plurality of laminated internal conductive layers.

According to example embodiments of the present invention, it is possible to provide multilayer ceramic electronic components that are each able to reduce the thickness of external electrodes while maintaining the bonding property between internal conductive layers and the external electrodes.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view of a multilayer ceramic capacitor of an example embodiment of the present invention.

FIG. 2 is a cross-sectional view taken along the line II-II of the multilayer ceramic capacitor of FIG. 1.

FIG. 3 is a cross-sectional view taken along the line III-III of the multilayer ceramic capacitor of FIG. 2.

FIG. 4 is a cross-sectional view taken along the line IV-IV of the multilayer ceramic capacitor of FIG. 2.

FIG. 5 is an enlarged view of a portion V of the multilayer ceramic capacitor of FIG. 2, and is a schematic view for explaining a joining portion between an end surface-side base electrode layer and an end surface-side electrically conductive resin layer of the multilayer ceramic capacitor.

FIG. 6 is a schematic view of an example of a configuration of a multilayer ceramic capacitor having a two-portion structure.

FIG. 7 is a schematic view of an example of a configuration of a multilayer ceramic capacitor having a three-portion structure.

FIG. 8 is a schematic view of an example of a configuration of a multilayer ceramic capacitor having a four-portion structure.

### DETAILED DESCRIPTION OF THE EXAMPLE EMBODIMENTS

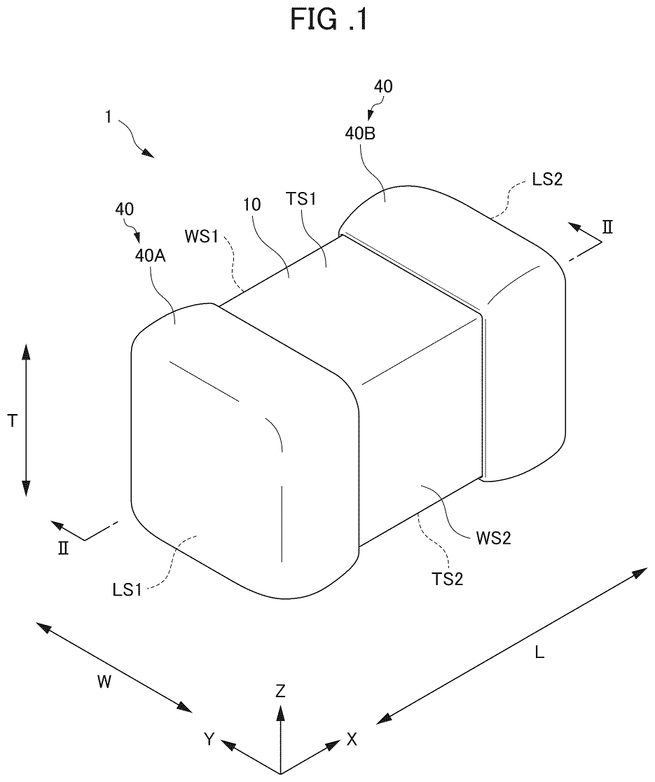

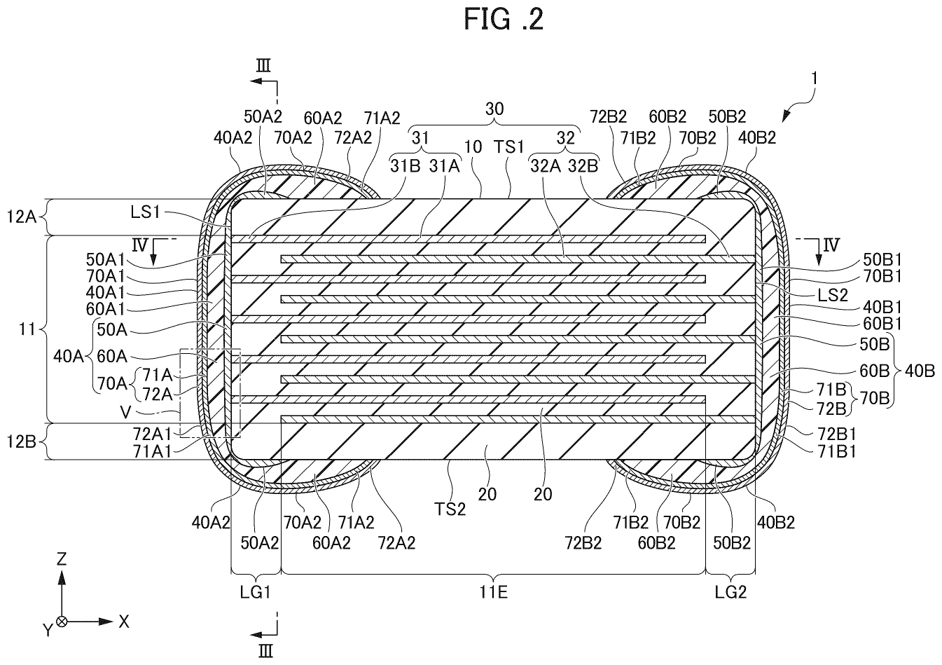

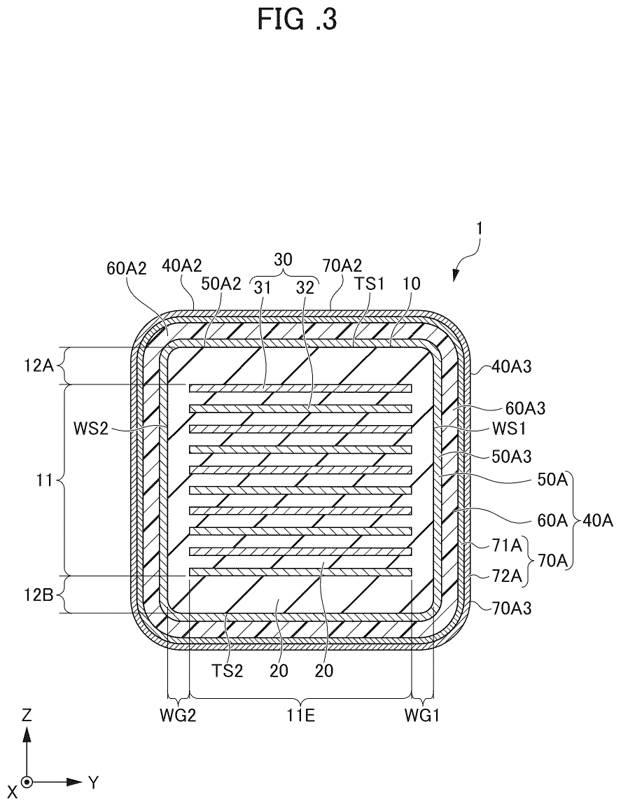

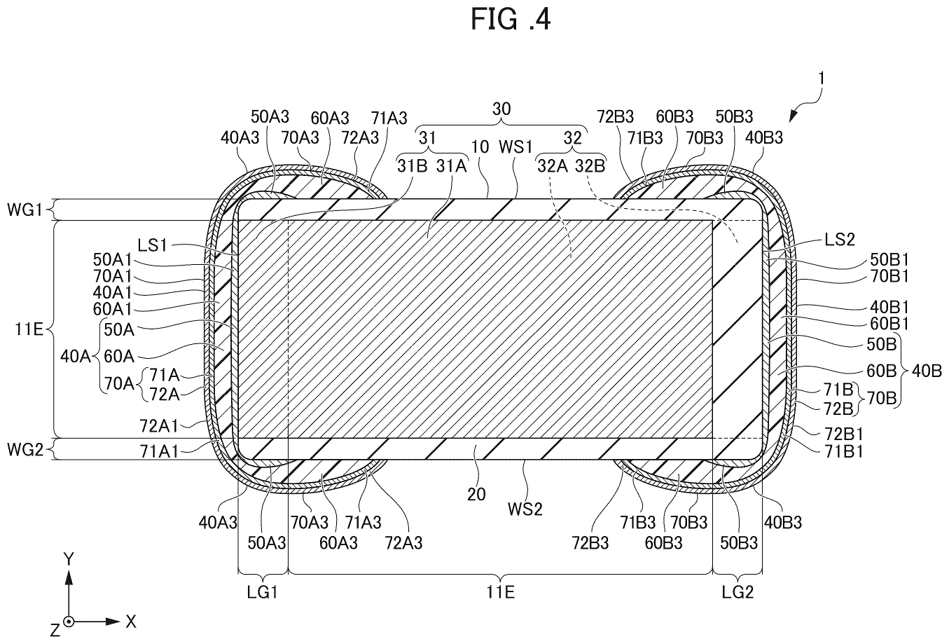

Hereinafter, a multilayer ceramic capacitor 1 functioning as a multilayer ceramic electronic component according to a first example embodiment of the present invention will be described with reference to FIGS. 1 to 4. FIG. 1 is an external perspective view of a multilayer ceramic capacitor 1 of the present example embodiment. FIG. 2 is a cross-sectional view of the multilayer ceramic capacitor 1 taken along the line II-II of FIG. 1. FIG. 3 is a cross-sectional view of the multilayer ceramic capacitor 1 taken along the line III-III of FIG. 2. FIG. 4 is a cross-sectional view of the multilayer ceramic capacitor 1 taken along the line IV-IV of FIG. 2.

In the drawings, in order to explain the contents of example embodiments of the present invention, the drawings may be schematically simplified, and the ratio of the drawn components or the dimensions between the components may not coincide with the ratio of the dimensions described in the specification. Further, components described in the specification may be omitted in the drawings, or the number of components may be omitted. For example, the number of internal electrode layers shown in FIGS. 2 and 3 is 10 for convenience of explanation, but this does not indicate the number of actual internal electrode layers 30. Further, the terms for specifying the shape and geometric conditions and the degree of the shape and geometric conditions used in the present invention, for example, the terms such as “parallel”, “orthogonal”, and “same” and the value of the length and angle, are not limited to the strict meaning, but are to be construed as including a range of a degree that can expect a similar function.

The multilayer ceramic capacitor 1 includes a multilayer body 10 and external electrodes 40.

FIGS. 1 to 4 each show an XYZ orthogonal coordinate system. The length direction L of the multilayer ceramic capacitor 1 and the multilayer body 10 corresponds to the X direction. The width direction W of the multilayer ceramic capacitor 1 and the multilayer body 10 corresponds to the Y direction. The lamination (stacking) direction T as the height direction of the multilayer ceramic capacitor 1 and the multilayer body 10 corresponds to the Z direction. Here, the cross section shown in FIG. 2 is also referred to as an LT cross section. The cross section shown in FIG. 3 is also referred to as a WT cross section. The cross section shown in FIG. 4 is also referred to as an LW cross section.

As shown in FIGS. 1 to 4, the multilayer body 10 includes a first main surface TS1 and a second main surface TS2 which are opposed to each other in the lamination direction T, a first lateral surface WS1 and a second lateral surface WS2 which are opposed to each other in the width direction W orthogonal or substantially orthogonal to the lamination direction T, and a first end surface LS1 and a second end surface LS2 which are opposed to each other in the length direction L orthogonal or substantially orthogonal to the lamination direction T and the width direction W.

As shown in FIG. 1, the multilayer body 10 has a substantially rectangular parallelepiped shape. The dimension in the length direction L of the multilayer body 10 is not necessarily longer than the dimension in the width direction W. The corner portions and ridge portions of the multilayer body 10 are preferably rounded. Each of the corner portions is a portion where the three surfaces of the multilayer body 10 intersect, and each of the ridge portions is a portion where the two surfaces of the multilayer body 10 intersect. In addition, unevenness or the like may be provided on a portion or the entirety of the surface of the multilayer body 10.

The dimension of the multilayer body 10 is not particularly limited, but when the dimension in the length direction L of the multilayer body 10 is defined as an L dimension, the L dimension is preferably about 0.2 mm or more and about 10 mm or less, for example. When the dimension of the multilayer body 10 in the lamination direction T is defined as a T dimension, the T dimension is preferably about 0.1 mm or more and about 10 mm or less, for example. When the dimension of the multilayer body 10 in the width direction W is defined as a W direction, the dimension W is preferably about 0.1 mm or more and about 10 mm or less, for example.

As shown in FIGS. 2 and 3, the multilayer body 10 includes an inner layer portion 11, and a first main surface-side outer layer portion 12A functioning as a first outer layer portion and a second main surface-side outer layer portion 12B functioning as a second outer layer portion sandwiching the inner layer portion 11 in the lamination direction T.

The inner layer portion 11 includes a plurality of dielectric layers 20 functioning as a plurality of ceramic layers and a plurality of internal electrode layers 30 functioning as a plurality of internal conductive layers. The inner layer portion 11 includes an internal electrode layer 30 positioned closest to the first main surface TS1 to an internal electrode layer 30 positioned closest to the second main surface TS2 in the lamination direction T. In the inner layer portion 11, the plurality of internal electrode layers 30 are opposed to each other with each of the plurality of dielectric layers 20 interposed therebetween. The inner layer portion 11 is a portion that substantially functions as a capacitor to generate capacitance.

The plurality of dielectric layers 20 are made of a dielectric material. The dielectric material may be, for example, a dielectric ceramic including components such as BaTiO₃, CaTiO₃, SrTiO₃, or CaZrO₃. Further, the dielectric material may be a material obtained by adding subcomponents such as Mn compound, Fe compound, Cr compound, Co compound, and Ni compound to these main components.

The thickness of each of the plurality of dielectric layers 20 is preferably about 0.5 μm or more and about 15 μm or less, for example. The number of laminated dielectric layers 20 is preferably 10 or more and 700 or less, for example. The number of dielectric layers 20 is a total number of the number of dielectric layers of the inner layer portion 11 and the number of dielectric layers of the first main surface-side outer layer portion 12A and the second main surface-side outer layer portion 12B.

The plurality of internal electrode layers 30 includes first internal electrode layers 31 functioning as a plurality of first internal conductive layers and second internal electrode layers 32 functioning as a plurality of second internal conductive layers. The plurality of first internal electrode layers 31 are provided on the plurality of dielectric layers 20. The plurality of second internal electrode layers 32 are provided on the plurality of dielectric layers 20. The plurality of first internal electrode layers 31 and the plurality of second internal electrode layers 32 are alternately provided with each of the plurality of dielectric layers 20 interposed therebetween in the lamination direction T of the multilayer body 10. One of the first internal electrode layers 31 and one of the second internal electrode layers 32 sandwich one of the dielectric layers 20.

Each of the plurality of first internal electrode layers 31 includes a first counter portion 31A opposed to each of the plurality of second internal electrode layers 32, and a first extension portion 31B extending from the first counter portion 31A toward the first end surface LS1. The first extension portion 31B is exposed at the first end surface LS1.

Each of the plurality of second internal electrode layers 32 includes a second counter portion 32A opposed to each of the plurality of first internal electrode layers 31, and a second extension portion 32B extending from the second counter portion 32A toward the second end surface LS2. The second extension portion 32B is exposed at the second end surface LS2.

In the present example embodiment, the first counter portion 31A and the second counter portion 32A are opposed to each other with the dielectric layer 20 interposed therebetween, such that a capacitance is generated, and the characteristics of the capacitor are developed.

The shapes of each of the first counter portions 31A and each of the second counter portions 32A are not particularly limited, but are preferably rectangular, for example. However, each of the corner portions of the rectangular shape may be rounded, or each of the corner portions of the rectangular shape may include an oblique portion. The shapes of each of the plurality of first extension portions 31B and each of the plurality of second extension portions 32B are not particularly limited, but are preferably rectangular, for example. However, each of the corner portions of the rectangular shape may be rounded, or each of the corner portions of the rectangular shape may include an oblique portion.

The dimension of each of the plurality of first counter portions 31A in the width direction W and the dimension of each of the plurality of first extension portions 31B in the width direction W may be the same, or either one of them may be smaller. The dimension of each of the plurality of second counter portions 32A in the width direction W and the dimension of each of the plurality of second extension portions 32B in the width direction W may be the same, or either one of them may be narrower.

Each of the plurality of first internal electrode layers 31 and each of the plurality of second internal electrode layers 32 are made of an appropriate electrically conductive material such as a metal such as Ni, Cu, Ag, Pd, or Au, or an alloy including at least one of these metals. When an alloy is used, each of the plurality of first internal electrode layers 31 and each of the plurality of second internal electrode layers 32 may be made of, for example, an Ag—Pd alloy.

Each of the thicknesses of the plurality of first internal electrode layers 31 and the plurality of second internal electrode layers 32 are preferably, for example, about 0.2 μm or more and 2.0 μm or less. The total number of the plurality of first internal electrode layers 31 and the plurality of second internal electrode layers 32 is preferably 10 or more and 700 or less, for example.

The first main surface-side outer layer portion 12A is positioned adjacent to the first main surface TS1 of the multilayer body 10. The first main surface-side outer layer portion 12A is an aggregate of a plurality of dielectric layers 20 positioned between the first main surface TS1 and the internal electrode layer 30 closest to the first main surface TS1. The dielectric layers 20 in the first main surface-side outer layer portion 12A may be the same as the dielectric layers 20 in the inner layer portion 11, or may be dielectric layers made of a different material.

The second main surface-side outer layer portion 12B is positioned adjacent to the second main surface TS2 of the multilayer body 10. The second main surface-side outer layer portion 12B is an aggregate of a plurality of dielectric layers 20 positioned between the second main surface TS2 and the internal electrode layer 30 closest to the second main surface TS2. The dielectric layers 20 in the second main surface-side outer layer portion 12B may be the same as the dielectric layers 20 in the inner layer portion 11, or may be a dielectric layer made of a different material.

The multilayer body 10 includes a counter electrode portion 11E. The counter electrode portion 11E is a portion where the first counter portions 31A of the first internal electrode layers 31 and the second counter portions 32A of the second internal electrode layers 32 are opposed to each other. The counter electrode portion 11E is a portion of the inner layer portion 11. FIG. 4 shows the range in the width direction W and the length direction L of the counter electrode portion 11E. The counter electrode portion 11E is also referred to as a capacitor effective portion.

The multilayer body 10 includes lateral surface-side outer layer portions. The lateral surface-side outer layer portion includes a first lateral surface-side outer layer portion WG1 and a second lateral surface-side outer layer portion WG2. The first lateral surface-side outer layer portion WG1 is a portion including the dielectric layers 20 positioned between the counter electrode portion 11E and the first lateral surface WS1. The second lateral surface-side outer layer portion WG2 is a portion including the dielectric layers 20 positioned between the counter electrode portion 11E and the second lateral surface WS2. FIGS. 3 and 4 each show the ranges in the width direction W of the first lateral surface-side outer layer portion WG1 and the second lateral surface-side outer layer portion WG2. The lateral surface-side outer layer portions are also each referred to as a W gap or a side gap.

The multilayer body 10 includes end surface-side outer layer portions. The end surface-side outer layer portions include a first end surface-side outer layer portion LG1 and a second end surface-side outer layer portion LG2. The first end surface-side outer layer portion LG1 is a portion including the dielectric layers 20 positioned between the counter electrode portion 11E and the first end surface LS1. The second end surface-side outer layer portion LG2 is a portion including the dielectric layers 20 positioned between the counter electrode portion 11E and the second end surface LS2. FIGS. 2 and 4 each show a range in the length direction L of the first end surface-side outer layer portion LG1 and the second end surface-side outer layer portion LG2. The end surface-side outer layer portions are also each referred to as an L gap or an end gap.

The external electrodes 40 include a first external electrode 40A on and adjacent to the first end surface LS1 and a second external electrode 40B on and adjacent to the second end surface LS2.

The first external electrode 40A is provided on the first end surface LS1. The first external electrode 40A is connected to the first internal electrode layers 31. The first external electrode 40A may also be provided on a portion of the first main surface TS1 and a portion of the second main surface TS2, and also on a portion of the first lateral surface WS1 and a portion of the second lateral surface WS2. In the present example embodiment, the first external electrode 40A includes a first end surface-side external electrode 40A1, a first main surface-side external electrode 40A2, and a first lateral surface-side external electrode 40A3. The first end surface-side external electrode 40A1 is provided on the first end surface LS1. The first main surface-side external electrode 40A2 is connected to the first end surface-side external electrode 40A1, and is provided on a portion of the first main surface TS1 and the second main surface TS2 adjacent to the first end surface LS1. The first lateral surface-side external electrode 40A3 is connected to the first end surface-side external electrode 40A1, and is provided on a portion on the first lateral surface WS1 and the second lateral surface WS2 adjacent to the first end surface LS1. Thus, the first external electrode 40A extends from the first end surface LS1 to a portion of the first main surface TS1 and a portion of the second main surface TS2, and to a portion of the first lateral surface WS1 and a portion of the second lateral surface WS2.

The second external electrode 40B is provided on the second end surface LS2. The second external electrode 40B is connected to the second internal electrode layers 32. The second external electrode 40B may also be provided on a portion of the first main surface TS1 and a portion of the second main surface TS2, and also on a portion of the first lateral surface WS1 and a portion of the second lateral surface WS2. In the present example embodiment, the second external electrode 40B includes a second end surface-side external electrode 40B1, a second main surface-side external electrode 40B2, and a second lateral surface-side external electrode 40B3. The second end surface-side external electrode 40B1 is provided on the second end surface LS2. The second main surface-side external electrode 40B2 is connected to the second end surface-side external electrode 40B1, and is provided on a portion of the first main surface TS1 and a portion of the second main surface TS2 adjacent to the second end surface LS2. The second lateral surface-side external electrode 40B3 is connected to the second end surface-side external electrode 40B1, and is provided on a portion of the first lateral surface WS1 and a portion of the second lateral surface WS2 adjacent to the second end surface LS2. Thus, the second external electrode 40B extends from the second end surface LS2 to a portion of the first main surface TS1 and a portion of the second main surface TS2, and to a portion of the first lateral surface WS1 and a portion of the second lateral surface WS2.

As described above, in the multilayer body 10, the first counter portions 31A of the first internal electrode layers 31 and the second counter portions 32A of the second internal electrode layers 32 are opposed to each other with each of the dielectric layers 20 interposed therebetween, such that a capacitance is generated. Therefore, the characteristic of the capacitor is developed between the first external electrode 40A to which the first internal electrode layers 31 are connected and the second external electrode 40B to which the second internal electrode layers 32 are connected.

The first external electrode 40A includes a first base electrode layer 50A including a metal component, a first electrically conductive resin layer 60A provided on the first base electrode layer 50A, and a first plated layer 70A provided on the first electrically conductive resin layer 60A.

The first base electrode layer 50A includes a first end surface-side base electrode layer 50A1, a first main surface-side base electrode layer 50A2, and a first lateral surface-side base electrode layer 50A3.

The first electrically conductive resin layer 60A includes a first end surface-side electrically conductive resin layer 60A1, a first main surface-side electrically conductive resin layer 60A2, and a first lateral surface-side electrically conductive resin layer 60A3.

The first plated layer 70A includes a first end surface-side plated layer 70A1, a first main surface-side plated layer 70A2, and a first lateral surface-side plated layer 70A3. The first plated layer 70A may include a two-layer structure including a first Ni plated layer 71A functioning as a lower plated layer and a first Sn plated layer 72A functioning as an upper plated layer. The first Ni plated layer 71A includes a first end surface-side Ni plated layer 71A1, a first main surface-side Ni plated layer 71A2, and a first lateral surface-side Ni plated layer 71A3. The first Sn plated layer 72A includes a first end surface-side Sn plated layer 72A1, a first main surface-side Sn plated layer 72A2, and a first lateral surface-side Sn plated layer 72A3.

The second external electrode 40B includes a second base electrode layer 50B including a metal component, a second electrically conductive resin layer 60B provided on the second base electrode layer 50B, and a second plated layer 70B provided on the second electrically conductive resin layer 60B.

The second base electrode layer 50B includes a second end surface-side base electrode layer 50B1, a second main surface-side base electrode layer 50B2, and a second lateral surface-side base electrode layer 50B3.

The second electrically conductive resin layer 60B includes a second end surface-side electrically conductive resin layer 60B1, a second main surface-side electrically conductive resin layer 60B2, and a second lateral surface-side electrically conductive resin layer 60B3.

The second plated layer 70B includes a second end surface-side plated layer 70B1, a second main surface-side plated layer 70B2, and a second lateral surface-side plated layer 70B3. The second plated layer 70B may include a two-layer structure including a second Ni plated layer 71B functioning as a lower plated layer and a second Sn plated layer 72B functioning as an upper plated layer. The second Ni plated layer 71B includes a second end surface-side Ni plated layer 71B1, a second main surface-side Ni plated layer 71B2, and a second lateral surface-side Ni plated layer 71B3. The second Sn plated layer 72B includes a second end surface-side Sn plated layer 72B1, a second main surface-side Sn plated layer 72B2, and a second lateral surface-side Sn plated layer 72B3.

Here, the basic configuration of the respective layers of the first external electrode 40A and the second external electrode 40B are the same or substantially the same. The first external electrode 40A and the second external electrode 40B are substantially plane symmetrical with respect to the LW cross section in the middle in the length direction L of the multilayer ceramic capacitor 1. Therefore, in a case where it is not necessary to particularly distinguish between the first external electrode 40A and the second external electrode 40B, the first external electrode 40A and the second external electrode 40B may be collectively referred to as an external electrode 40. In a case where there is no need to particularly distinguish between the first base electrode layer 50A and the second base electrode layer 50B, the first base electrode layer 50A and the second base electrode layer 50B may be collectively referred to as a base electrode layer 50. In addition, in a case where it is not necessary to particularly distinguish between the first end surface-side base electrode layer 50A1 and the second end surface-side base electrode layer 50B1, the first end surface-side base electrode layer 50A1 and the second end surface-side base electrode layer 50B1 may be collectively referred to as an end surface-side base electrode layer 501.

In a case where it is not necessary to particularly distinguish between the first electrically conductive resin layer 60A and the second electrically conductive resin layer 60B, the first electrically conductive resin layer 60A and the second electrically conductive resin layer 60B may be collectively referred to as an electrically conductive resin layer 60. Further, in a case where it is not necessary to particularly distinguish between the first end surface-side electrically conductive resin layer 60A1 and the second end surface-side electrically conductive resin layer 60B1, the first end surface-side electrically conductive resin layer 60A1 and the second end surface-side electrically conductive resin layer 60B1 may be collectively referred to as an end surface-side electrically conductive resin layer 601.

In a case where it is not necessary to particularly distinguish between the first plated layer 70A and the second plated layer 70B, the first plated layer 70A and the second plated layer 70B may be collectively referred to as a plated layer 70. Further, in a case where it is not necessary to particularly distinguish between the first end surface-side plated layer 70A1 and the second end surface-side plated layer 70B1, the first end surface-side plated layer 70A1 and the second end surface-side plated layer 70B1 may be collectively referred to as an end surface-side plated layer 701. In a case where it is not necessary to particularly distinguish between the first Ni plated layer 71A and the second Ni plated layer 71B, the first Ni plated layer 71A and the second Ni plated layer 71B may be collectively referred to as a Ni plated layer 71. In a case where it is not necessary to particularly distinguish between the first Sn plated layer 72A and the second Sn plated layer 72B, the first Sn plated layer 72A and the second Sn plated layer 72B may be collectively referred to as the Sn plated layer 72. When it is not necessary to particularly distinguish between the first end surface-side Ni plated layer 71A1 and the second end surface-side Ni plated layer 71B1, the first end surface-side Ni plated layer 71A1 and the second end surface-side Ni plated layer 71B1 may be collectively referred to as an end surface-side Ni plated layer 711. In addition, when it is not necessary to particularly distinguish between the first end surface-side Sn plated layer 72A1 and the second end surface-side Sn plated layer 72B1, the first end surface-side Sn plated layer 72A1 and the second end surface-side Sn plated layer 72B1 may be collectively referred to as an end surface-side Sn plated layer 721.

When it is not necessary to particularly distinguish between the first end surface LS1 and the second end surface LS2, the first end surface LS1 and the second end surface LS2 may be collectively referred to as an end surface LS.

In addition, when it is not necessary to particularly distinguish between the first main surface-side outer layer portion 12A and the second main surface-side outer layer portion 12B, the first main surface-side outer layer portion 12A and the second main surface-side outer layer portion 12B may be collectively referred to as the outer layer portion 12.

Next, the base electrode layer 50 will be described. The base electrode layer 50 includes a first base electrode layer 50A and a second base electrode layer 50B.

The first base electrode layer 50A is provided on the first end surface LS1. The first base electrode layer 50A is connected to the first internal electrode layers 31. Further, the first base electrode layer 50A may also be provided on a portion of the first main surface TS1, a portion of the second main surface TS2, a portion of the first lateral surface WS1, and a portion of the second lateral surface WS2. In the present example embodiment, the first base electrode layer 50A extends from the first end surface LS1 to a portion of the first main surface TS1 and a portion of the second main surface TS2, and to a portion of the first lateral surface WS1 and a portion of the second lateral surface WS2. More specifically, the first base electrode layer 50A is provided such that the first end surface-side base electrode layer 50A1 described above is provided on the first end surface LS1, the first main surface-side base electrode layer 50A2 described above extends from the first end surface LS1 to a portion of the first main surface TS1 and a portion of the second main surface TS2, and the first lateral surface-side base electrode layer 50A3 described above extends from the first end surface LS1 to a portion of the first lateral surface WS1 and a portion of the second lateral surface WS2.

The second base electrode layer 50B is provided on the second end surface LS2. The second base electrode layer SOB is connected to the second internal electrode layers 32. Further, the second base electrode layer SOB may also be provided on a portion of the first main surface TS1, a portion of the second main surface TS2, a portion of the first lateral surface WS1, and a portion of the second lateral surface WS2. In the present example embodiment, the second base electrode layer SOB extends from the second end surface LS2 to a portion of the first main surface TS1 and a portion of the second main surface TS2, and to a portion of the first lateral surface WS1 and a portion of the second lateral surface WS2. More specifically, the second base electrode layer SOB is provided such that the second end surface-side base electrode layer 50B1 described above is provided on the second end surface LS2, the second main surface-side base electrode layer 50B2 described above extends from the second end surface LS2 to a portion of the first main surface TS1 and a portion of the second main surface TS2, and the second lateral surface-side base electrode layer 50B3 described above extends from the second end surface LS2 to a portion of the first lateral surface WS1 and a portion of the second lateral surface WS2.

The first base electrode layer 50A and the second base electrode layer 50B of the present example embodiment are fired layers. The fired layers each preferably includes a metal component and either or both of a glass component and a ceramic component. Thus, the adhesion between the multilayer body 10 and the base electrode layer 50 can be improved. The metal component includes, for example, at least one selected from Cu, Ni, Ag, Pd, Ag—Pd alloy, Au, or the like. The glass component includes, for example, at least one selected from B, Si, Ba, Mg, Al, Li, or the like. When a glass component is present, sintering of the metal component in the base electrode layer can be promoted and advanced. The ceramic component may be a ceramic material of the same kind as the dielectric layer 20 or a ceramic material of a different kind. The ceramic component includes, for example, at least one selected from BaTiO₃, CaTiO₃, (Ba, Ca)TiO₃, SrTiO₃, CaZrO₃, or the like.

The fired layer is formed, for example, by coating a multilayer body with an electrically conductive paste including glass and metal and firing the resulting product. The fired layer may be obtained by simultaneously firing a multilayer chip having internal electrode layers and dielectric layers and an electrically conductive paste applied to the multilayer chip, or may be obtained by firing a multilayer chip having internal electrode layers and dielectric layers to obtain a multilayer body, and then firing the multilayer body by applying the electrically conductive paste to the multilayer body. In a case where the multilayer chip having the internal electrode layers and the dielectric layers, and the electrically conductive paste applied to the multilayer chip are simultaneously fired, the fired layer including a ceramic material instead of the glass component is preferably formed. In this case, it is particularly preferable to use the same kind of ceramic material as the dielectric layer 20 as the ceramic material to be added. The fired layer may include a plurality of layers.

The thickness in the length direction of the first end surface-side base electrode layer 50A1 positioned at the first end surface LS1 is preferably, for example, about 2 μm or more and about 220 μm or less in the middle of the first end surface-side base electrode layer 50A1 in the lamination direction T and the width direction W. A more preferable range of the thickness in the length direction of the first end surface-side base electrode layer 50A1 is about 10 μm or more and about 45 μm or less, for example.

The thickness in the length direction of the second end surface-side base electrode layer 50B1 positioned at the second end surface LS2 is preferably, for example, about 2 μm or more and about 220 μm or less in the middle of the second end surface-side base electrode layer 50B1 in the lamination direction T and the width direction W. A more preferable range of the thickness in the length direction of the second end surface-side base electrode layer 50B1 is about 10 μm or more and about 45 μm or less, for example.

In a case where the first base electrode layer 50A is provided also on a portion of at least one surface of the first main surface TS1 or the second main surface TS2, the thickness of the first main surface-side base electrode layer 50A2 provided on this portion in the lamination direction is preferably, for example, about 4 μm or more and about 40 μm or less in the middle in the length direction L and the width direction W of the first main surface-side base electrode layer 50A2 provided on this portion. A more preferable range of the thickness of the first main surface-side base electrode layer 50A2 in the lamination direction is about 2 μm or more and about 15 μm or less, for example.

In a case where the first base electrode layer 50A is provided also on a portion of at least one of the first lateral surface WS1 and the second lateral surface WS2, the thickness in the width direction of the first lateral surface-side base electrode layer 50A3 provided on this portion is preferably, for example, about 4 μm or more and about 40 μm or less in the middle in the length direction L and the lamination direction T of the first lateral surface-side base electrode layer 50A3 provided on this portion. A more preferable range of the thickness in the width direction of the first lateral surface-side base electrode layer 50A3 is about 2 μm or more and about 15 μm or less, for example.

In a case where the second base electrode layer 50B is provided on a portion of at least one surface of the first main surface TS1 or the second main surface TS2, the thickness of the second main surface-side base electrode layer 50B2 provided on this portion in the lamination direction is preferably, for example, about 4 μm or more and about 40 μm or less in the middle in the length direction L and the width direction W of the second main surface-side base electrode layer 50B2 provided on this portion. A more preferable range of the thickness of the second main surface-side base electrode layer 50B2 in the lamination direction is about 2 μm or more and about 15 μm or less, for example.

In a case where the second base electrode layer 50B is provided also on a portion of at least one of the first lateral surface WS1 and the second lateral surface WS2, the thickness in the width direction of the second lateral surface-side base electrode layer 50B3 provided on this portion is preferably, for example, about 4 μm or more and about 40 μm or less in the middle in the length direction L and the lamination direction T of the second lateral surface-side base electrode layer 50B3 provided on this portion. A more preferable range of the thickness of the second lateral surface-side base electrode layer 50B3 in the width direction is about 2 μm or more and about 15 μm or less, for example.

Each of the external electrodes 40 includes an electrically conductive resin layer 60 including a resin component and a metal component provided on the base electrode layer 50. The electrically conductive resin layer 60 includes a first electrically conductive resin layer 60A and a second electrically conductive resin layer 60B.

The first electrically conductive resin layer 60A covers the first base electrode layer 50A. The first electrically conductive resin layer 60A includes an end portion which is preferably in contact with the multilayer body 10. The end portion of the first electrically conductive resin layer 60A indicates a portion of the first electrically conductive resin layer 60A closer to the second end surface LS2 than the first base electrode layer 50A in the length direction L. In the present example embodiment, the first electrically conductive resin layer 60A is provided such that the first end surface-side electrically conductive resin layer 60A1 described above is provided on the first end surface LS1, the first main surface-side electrically conductive resin layer 60A2 described above extends from the first end surface LS1 to a portion of the first main surface TS1 and a portion of the second main surface TS2, and the first lateral surface-side electrically conductive resin layer 60A3 described above extends from the first end surface LS1 to a portion of the first lateral surface WS1 and a portion of the second lateral surface WS2.

The second electrically conductive resin layer 60B covers the second base electrode layer 50B. The second electrically conductive resin layer 60B includes an end portion which is preferably in contact with the multilayer body 10. The end portion of the second electrically conductive resin layer 60B indicates a portion of the second electrically conductive resin layer 60B closer to the first end surface LS1 than the second base electrode layer 50B in the length direction L. In the present example embodiment, the second electrically conductive resin layer 60B is provided such that the second end surface-side electrically conductive resin layer 60B1 described above is provided on the second end surface LS2, the second main surface-side electrically conductive resin layer 60B2 described above extends from the second end surface LS2 to a portion of the first main surface TS1 and a portion of the second main surface TS2, and the second lateral surface-side electrically conductive resin layer 60B3 described above extends from the second end surface LS2 to a portion of the first lateral surface WS1 and a portion of the second lateral surface WS2.

The thickness in the length direction of the first end surface-side electrically conductive resin layer 60A1 positioned adjacent to the first end surface LS1 is preferably, for example, about 10 μm or more and about 200 μm or less in the middle of the first end surface-side electrically conductive resin layer 60A1 in the lamination direction T and the width direction W.

The thickness in the length direction of the second end surface-side electrically conductive resin layer 60B1 positioned adjacent to the second end surface LS2 is preferably, for example, about 10 μm or more and about 200 μm or less in the middle of the second end surface-side electrically conductive resin layer 60B1 in the lamination direction T and the width direction W.

In a case where the first electrically conductive resin layer 60A is also provided on a portion of the first main surface TS1 and a portion of the second main surface TS2, the thickness in the lamination direction T of the first main surface-side electrically conductive resin layer 60A2 provided on this portion is preferably, for example, about 10 μm or more and about 200 μm or less in the middle of the first main surface-side electrically conductive resin layer 60A2 provided on this portion in the length direction L and the width direction W.

In a case where the first electrically conductive resin layer 60A is also provided on a portion of the first lateral surface WS1 and a portion of the second lateral surface WS2, the thickness in the width direction W of the first lateral surface-side electrically conductive resin layer 60A3 provided on this portion is preferably, for example, about 10 μm or more and about 200 μm or less in the middle of the first lateral surface-side electrically conductive resin layer 60A3 provided on this portion in the length direction L and the lamination direction T.

In a case where the second electrically conductive resin layer 60B is also provided on a portion of the first main surface TS1 and a portion of the second main surface TS2, the thickness of the second main surface-side electrically conductive resin layer 60B2 provided on this portion in the lamination direction T is preferably, for example, about 10 μm or more and about 200 μm or less in the middle of the second main surface-side electrically conductive resin layer 60B2 provided on this portion in the length direction L and the width direction W.

In a case where the second electrically conductive resin layer 60B is also provided on a portion of the first lateral surface WS1 and a portion of the second lateral surface WS2, the thickness in the width direction W of the second lateral surface-side electrically conductive resin layer 60B3 provided on this portion is preferably, for example, about 10 μm or more and 200 μm or less in the middle of the second lateral surface-side electrically conductive resin layer 60B3 provided on this portion in the length direction L and the lamination direction T.

The electrically conductive resin layer 60 is provided on the base electrode layer 50. The internal configuration of the electrically conductive resin layer 60 will be described later in the description of the end surface-side electrically conductive resin layer 601. The plated layer 70 covers the electrically conductive resin layer 60. The plated layer 70 includes a Ni plated layer 71 and a Sn plated layer 72.

The plated layer 70 includes a first plated layer 70A and a second plated layer 70B.

The first plated layer 70A covers the first electrically conductive resin layer 60A. In the present example embodiment, the first plated layer 70A extends from the first end surface LS1 to a portion of the first main surface TS1 and a portion of the second main surface TS2, and to a portion of the first lateral surface WS1 and a portion of the second lateral surface WS2. More specifically, the first plated layer 70A is provided such that the first end surface-side plated layer 70A1 described above is provided on the first end surface LS1, the first main surface-side plated layer 70A2 described above extends from the first end surface LS1 to a portion of the first main surface TS1 and a portion of the second main surface TS2, and the first lateral surface-side plated layer 70A3 described above extends from the first end surface LS1 to a portion of the first lateral surface WS1 and a portion of the second lateral surface WS2.

The second plated layer 70B covers the second electrically conductive resin layer 60B. In the present example embodiment, the second plated layer 70B extends from the first end surface LS1 to a portion of the first main surface TS1 and a portion of the second main surface TS2, and to a portion of the first lateral surface WS1 and a portion of the second lateral surface WS2. More specifically, the second plated layer 70B is provided such that the second end surface-side plated layer 70B1 described above is provided on the second end surface LS2, the second main surface-side plated layer 70B2 described above extends from the second end surface LS2 to a portion of the first main surface TS1 and a portion of the second main surface TS2, and the second lateral surface-side plated layer 70B3 described above extends from the second end surface LS2 to a portion of the first lateral surface WS1 and a portion of the second lateral surface WS2.

The plated layer 70 preferably has a two-layer structure of a Ni plated layer 71 and a Sn plated layer 72. The first Sn plated layer 72A is preferably provided on the first Ni plated layer 71A, and the second Sn plated layer 72B is preferably provided on the second Ni plated layer 71B. In the present example embodiment, the first end surface-side Ni plated layer 71A1 and the first end surface-side Sn plated layer 72A1 are provided on the first end surface LS1, the first main surface-side Ni plated layer 71A2 and the first main surface-side Sn plated layer 72A2 extend from the first end surface LS1 to a portion of the first main surface TS1 and a portion of the second main surface TS2, and the first lateral surface-side Ni plated layer 71A3 and the first lateral surface-side Sn plated layer 72A3 described above extend from the first end surface LS1 to a portion of the first lateral surface WS1 and a portion of the second lateral surface WS2. Similarly, the second end surface-side Ni plated layer 71B1 and the second end surface-side Sn plated layer 72B1 are provided on the second end surface LS2, the second main surface-side Ni plated layer 71B2 and the second main surface-side Sn plated layer 72B2 extend from the second end surface LS2 to a portion of the first main surface TS1 and a portion of the second main surface TS2, and the second lateral surface-side Ni plated layer 71B3 and the second lateral surface-side Sn plated layer 72B3 described above extend from the second end surface LS2 to a portion of the first lateral surface WS1 and a portion of the second lateral surface WS2.

The Ni plated layer 71 prevents the base electrode layer 50 and the electrically conductive resin layer 60 from being eroded by solder when the multilayer ceramic capacitor 1 is mounted. The Sn plated layer 72 improves wettability of solder when mounting the multilayer ceramic capacitor 1. This facilitates mounting of the multilayer ceramic capacitor 1.

The thicknesses of the first Ni plated layer 71A and the first Sn plated layer 72A are preferably about 1 μm or more and about 15 μm or less, for example.

The thicknesses of the second Ni plated layer 71B and the second Sn plated layer 72B are preferably about 1 μm or more and about 15 μm or less, for example.

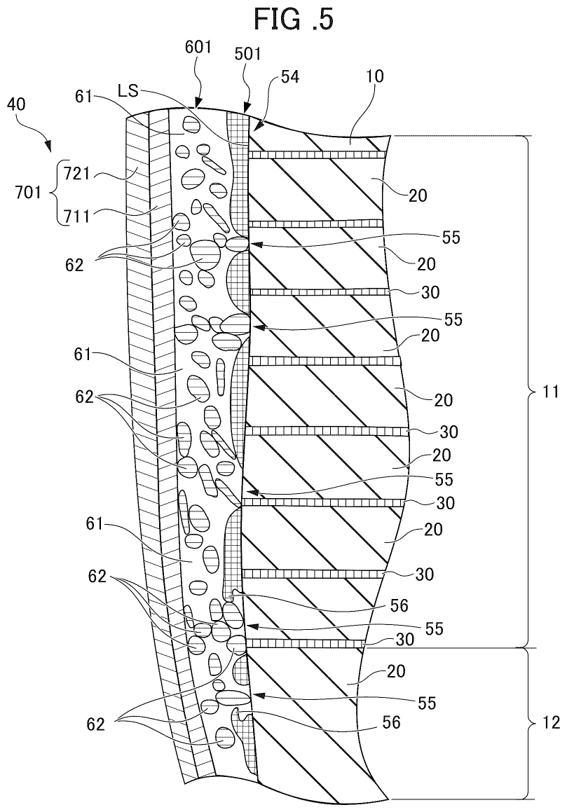

FIG. 5 is an enlarged view of a portion V of the multilayer ceramic capacitor 1 shown in FIG. 2, and is a schematic view for explaining a joining portion between the end surface-side base electrode layer 501 and the end surface-side electrically conductive resin layer 601 of the multilayer ceramic capacitor 1. As described above, since the basic configurations of the first external electrode 40A and the second external electrode 40B are the same, these are collectively described as the external electrode 40 with reference to FIG. 5. The same applies to other layers of the first external electrode 40A and the second external electrode 40B.

As described above, the external electrode 40 includes the end surface-side base electrode layer 501 provided on the end surface LS of the multilayer body 10, the end surface-side electrically conductive resin layer 601 provided on the end surface-side base electrode layer 501, and the end surface-side plated layer 701 provided on the end surface-side electrically conductive resin layer 601.

As shown in FIG. 5, the end surface-side base electrode layer 501 is not provided entirely or seamlessly on the end surface LS, but includes an intermittent region 54 in which the end surface-side base electrode layer 501 is intermittently present. The intermittent region 54 includes one or more interruption regions 55 in which the end surface LS is exposed at the end surface-side electrically conductive resin layer 601.

The range in which the intermittent region 54 is provided in the end surface-side base electrode layer 501 is not particularly limited, but is provided in a region of the inner layer portion 11 in the vicinity of the outer layer portion 12 as shown in FIG. 5. In the example of FIG. 5, a plurality of interruption regions 55 are provided, and the ratio of the presence of the interruption regions 55 tends to increase toward the outer layer portion 12.

The intermittent region 54 may be provided in a region other than the region in the vicinity of the outer layer portion 12 of the end surface-side base electrode layer 501. For example, the intermittent region 54 may be provided to extend from the inner layer portion 11 across the outer layer portion 12, and the end surface-side electrically conductive resin layer 601 may be in contact with the outer layer portion 12 in the interruption regions 55. The intermittent region 54 is provided in a region of the inner layer portion 11 in the vicinity of the outer layer portion 12 and the outer layer portion 12 on the end surface LS of the multilayer body 10, and may not be provided in the middle region in the height direction of the inner layer portion 11. The region of the inner layer portion 11 in the vicinity of the outer layer portion 12 may range from the boundary between the inner layer portion 11 and the outer layer portion 12 to a position of, for example, about 5% of the dimension of the inner layer portion in the lamination direction toward the middle of the inner layer portion 11 in the height direction.

Further, in the present example embodiment, the end surface-side base electrode layer 501 includes an anchor portion 56 provided in a portion of the portion adjacent to each of the interruption regions 55. The anchor portion 56 extends in the length direction of the multilayer body 10 from a portion in contact with the end surface LS of the multilayer body 10, and then bends in a direction intersecting the length direction L. The bending direction of the anchor portion 56 is preferably a direction approaching the end surface LS from the viewpoint of the anchor effect.

The anchor portion 56 is a portion like an undercut in the resin molding technology in which a space is provided between the anchor portion and the end surface LS when the end surface LS is viewed from the outside. In the length direction L, the end surface-side electrically conductive resin layer 601 is provided inside the space provided between the anchor portion 56 of the end surface-side base electrode layer 501 and the end surface LS. In FIG. 5, the anchor portion 56 bent in the lamination direction T as the height direction is shown, but the bending direction of the anchor portion 56 is not limited to the lamination direction T. The direction in which the anchor portion 56 is bent may be a direction intersecting the length direction L, and may be a direction in which a space in which the end surface-side electrically conductive resin layer 601 is provided between the anchor portion 56 and the end surface LS can be provided. For example, the anchor portion 56 may bend in the width direction W.

The end surface-side electrically conductive resin layer 601 provided on the end surface-side base electrode layer 501 is in contact with the end surface LS of the multilayer body 10 in the intermittent region 54 of the end surface-side base electrode layer 501. The end surface-side base electrode layer 501 may be in contact with only the dielectric layer 20 depending on the position of the intermittent region 54, or may be in contact with both the dielectric layer 20 and the first extension portion 31B of the internal electrode layer 30. Depending on the shape of the intermittent region 54, the end surface-side base electrode layer 501 may be in contact with only the first extension portion 31B of the internal electrode layer 30.

The internal configuration of the end surface-side electrically conductive resin layer 601 will be described. The main surface-side electrically conductive resin layer 602 and the lateral surface-side electrically conductive resin layer 603 have the same internal configuration as the end surface-side electrically conductive resin layer 601. That is, the internal configuration of the end surface-side electrically conductive resin layer 601 may be the internal configuration of the electrically conductive resin layer 60.

The end surface-side electrically conductive resin layer 601 includes a resin portion 61 and electrically conductive fillers 62 dispersed in the resin portion 61.

The resin portion 61 may include, for example, at least one of various known thermosetting resins such as epoxy resin, phenoxy resin, phenol resin, urethane resin, silicone resin, or polyimide resin. Among them, epoxy resins excelling in heat resistance, moisture resistance, adhesiveness and the like are the most suitable resins. The resin portion of the electrically conductive resin layer 60 preferably includes a curing agent together with the thermosetting resin. When an epoxy resin is used as the base resin, the curing agent of the epoxy resin may be any of various known compounds such as phenolic, amine-based, acid anhydride-based, imidazole-based, active ester-based, or amideimide-based compounds.

The resin portion 61 may include, for example, at least one of various known thermosetting resins such as epoxy resin, phenoxy resin, phenol resin, urethane resin, silicone resin, or polyimide resin. Among them, epoxy resins excelling in heat resistance, moisture resistance, adhesiveness and the like are the most suitable resins. The resin portion of the electrically conductive resin layer 60 preferably includes a curing agent together with the thermosetting resin. When an epoxy resin is used as the base resin, the curing agent of the epoxy resin may be any of various known compounds such as phenolic, amine-based, acid anhydride-based, imidazole-based, active ester-based, or amideimide-based compounds.

Since the end surface-side electrically conductive resin layer 601 includes such a resin portion 61, it is more flexible than, for example, the base electrode layer 50 made of a plated film or a fired product of a metal component and a glass component. Therefore, even when a physical impact or shock caused by thermal cycling is applied to the multilayer ceramic capacitor 1, the end surface-side electrically conductive resin layer 601 functions as a buffer layer. Accordingly, it is possible for the electrically conductive resin layer 60 to reduce or prevent the generation of cracks in the multilayer ceramic capacitor 1.

The electrically conductive filler 62 is dispersed in the resin portion in a uniform or substantially uniform distribution. The electrically conductive filler mainly maintains the conductivity of the electrically conductive resin layer 60. Specifically, when the plurality of electrically conductive fillers 62 are brought into contact with each other, an electric current-carrying path is provided inside the end surface-side electrically conductive resin layer 601, such that the base electrode layer 50 and the plated layer 70 are electrically connected to each other.

The metal of the electrically conductive filler 62 may be Ag alone, an alloy including Ag, or metal powder including Ag coating on the surface of the metal powder. Ag is suitable for electrode materials because of its lowest specific resistance among metals. Since Ag is a noble metal, it hardly oxidizes and the weatherability is high. Therefore, the metal powder of Ag is suitable as the electrically conductive filler 62. When a metal powder coated with Ag is used, Cu, Ni, Sn, Bi or an alloy powder including them is preferably used as the metal powder.

Further, the electrically conductive filler 62 may be formed by subjecting Cu and Ni to an oxidation preventing treatment. The electrically conductive filler may be a metal powder obtained by coating the surface of the metal powder with Sn, Ni, or Cu. When a metal powder coated with Sn, Ni, or Cu is used, the metal powder is preferably Ag, Cu, Ni, Sn, or Bi or an alloy powder thereof.

The shape of the electrically conductive filler 62 is not particularly limited. The electrically conductive filler 62 may have a spherical shape, a flat shape, or the like. Further, it is preferable to use a combination of metal powders having a spherical shape and a flat shape. Here, the spherical particles of the electrically conductive filler 62 may include a shape that is not perfectly spherical, and may include, for example, a shape in which the length ratio (long axis/short axis) of the long axis to the short axis is about 1.45 or less. The flat particles of the electrically conductive filler 62 indicate particles having a flat and elongated shape, and may have, for example, a length ratio (long axis/short axis) of about 1.95 or more between a long axis and a short axis without any particular limitation.

The average particle diameter of the electrically conductive filler 62 may be, for example, about 0.3 μm or more and about 10 μm or less, and more preferably about 1 μm or more and about 8 μm or less. When the electrically conductive filler 62 has a flat shape, the average long axis diameter of the planar portion of the electrically conductive filler 62 may be, for example, about 2 μm or more and about 10 μm or less, and more preferably about 5 μm or more and about 8 μm or less. When the electrically conductive filler 62 has a flat shape, the average short axis diameter of the planar portion of the electrically conductive filler 62 may be, for example, about 0.3 μm or more and about 3 μm or less, and more preferably about 0.5 μm or more and about 1 μm or less.

In the present example embodiment, a portion of the electrically conductive filler 62 included in the end surface-side electrically conductive resin layer 601 is in contact with the end surface LS in the interruption region 55. In the present example embodiment, a portion of the electrically conductive filler 62 in contact with the end surface LS is in contact with the first extension portion 31B or the second extension portion 32B functioning as an end portion of the internal electrode layer 30, and the end surface-side electrically conductive resin layer 601 and the internal electrode layer 30 are directly connected to each other. Further, a portion of the electrically conductive filler 62 is also in contact with the inner layer portion 11 exposed at the end surface LS. In the interruption region 55, there is also a portion where the end surface-side electrically conductive resin layer 601 is in contact with the end surface LS of the multilayer body 10 and is not in contact with the end portion of the internal electrode layer 30.

The average particle diameter of the electrically conductive filler 62 is preferably smaller than the dimension of the thickness of each of the dielectric layers 20. With such a configuration, the electrically conductive filler 62 is likely to enter the interruption region 55 of the intermittent region 54, and the probability of contact between the electrically conductive filler 62 and the internal electrode layer 30 increases. The average particle diameter of the electrically conductive filler 62 may be larger than the dimension of the thickness of each of the internal electrode layers 30 and smaller than the dimension of the thickness of each of the dielectric layers 20. The electrically conductive filler 62 preferably includes an electrically conductive filler having a flat shape. In a case where the electrically conductive filler 62 includes an electrically conductive filler having a flat shape, the average short axis diameter of the planar portion of the electrically conductive filler 62 is preferably smaller than the dimension of the thickness of each of the dielectric layers 20. With such a configuration, the electrically conductive filler 62 having a flat shape is likely to enter the interruption region 55 of the intermittent region 54, and the probability of contact between the electrically conductive filler 62 and the internal electrode layer 30 increases. In a case where the electrically conductive filler 62 includes an electrically conductive filler having a flat shape, the average short axis diameter of the planar portion of the electrically conductive filler 62 may be larger than the dimension of the thickness of each of the internal electrode layers 30 and smaller than the dimension of the thickness of each of the dielectric layers 20.

The average particle diameter of the electrically conductive filler 62 is preferably smaller than the dimension of the interruption region 55 of the intermittent region 54 in the height direction. In a case where the electrically conductive filler 62 includes an electrically conductive filler having a flat shape, the average minor axis diameter of the planar portion of the electrically conductive filler 62 is preferably smaller than the dimension in the height direction of the interruption region 55 of the intermittent region 54. With such a configuration, the electrically conductive filler 62 is likely to enter the interruption region 55 of the intermittent region 54, and the probability of contact between the electrically conductive filler 62 and the internal electrode layer 30 increases.

Further, a portion of the electrically conductive filler 62 included in the end surface-side electrically conductive resin layer 601 may be in contact with the end portion of the anchor portion 56. With such a configuration, electrical connectivity can be improved in the structure in which the end surface-side base electrode layer 501 includes the intermittent region 54.

When the dimension in the length direction of the multilayer ceramic capacitor 1 including the multilayer body 10 and the external electrode 40 is defined as an L dimension, the L dimension is preferably about 0.2 mm or more and about 10 mm or less, for example. When the dimension of the multilayer ceramic capacitor 1 in the lamination direction is defined as a T dimension, the T dimension is preferably about 0.1 mm or more and about 10 mm or less, for example. The dimension of the multilayer ceramic capacitor 1 in the width direction is defined as a W dimension. The W dimension is preferably about 0.1 mm or more and about 10 mm or less, for example.

Next, a method of measuring the average particle diameter of the electrically conductive filler 62 between the end surface-side base electrode layer 501 and the end surface-side electrically conductive resin layer 601 and a method of checking the contact state between the electrically conductive filler 62 and the internal electrode layer 30 in the present example embodiment will be described.

First, the multilayer ceramic capacitor 1 is polished from the first lateral surface WS1 or the second lateral surface WS2 to a position of about ½ of the dimension in the width direction W, for example. Then, the LT cross section in the middle position in the width direction W of the multilayer ceramic capacitor 1 is exposed. Next, the LT cross section exposed by polishing is observed by SEM. Specifically, a portion including the base electrode layer 50 in the LT cross section is imaged as a reflected electron image. In the reflected electron image, the difference in elements is reflected as contrast. In addition, the imaging magnification is set to 2000 times, and a portion of the base electrode layer 50 in the reflected electron image is set as an analysis target range. For example, as shown in FIG. 5, the reflected electron image acquisition position is set so as to include the end surface-side base electrode layer 501, the end surface-side electrically conductive resin layer 601, the inner layer portion 11, and the outer layer portion 12.

The acquired reflected electron image is binarized by the image analysis software “WinROOF (available from Mitani Corporation)” to identify the electrically conductive filler 62. The average particle diameter of the identified electrically conductive filler 62 is measured, and the contact state between the electrically conductive filler 62 and the internal electrode layer 30 in the interruption region 55 is confirmed.

Next, a method of manufacturing the multilayer ceramic capacitor 1 of the present example embodiment will be described. The method of manufacturing the multilayer ceramic capacitor 1 of the present example embodiment is not limited as long as it satisfies the above-mentioned requirements. However, a preferred manufacturing method includes the following processes. The details of each process will be described below.

A dielectric sheet for forming the dielectric layer 20 and an electrically conductive paste for forming the internal electrode layer 30 are prepared. The dielectric sheet and the electrically conductive paste for forming the internal electrodes include a binder and a solvent. The binder and the solvent may be well known.

The electrically conductive paste for forming the internal electrode layer 30 is printed on the dielectric sheet in a predetermined pattern by, for example, screen printing or gravure printing. Thus, a dielectric sheet having a pattern of the first internal electrode layer 31 and a dielectric sheet having a pattern of the second internal electrode layer 32 are prepared.

By laminating a predetermined number of dielectric sheets on which patterns of internal electrode layers are not printed, a portion functioning as the first main surface-side outer layer portion 12A adjacent to the first main surface TS1 is formed. A dielectric sheet on which the pattern of the first internal electrode layer 31 is printed and a dielectric sheet on which the pattern of the second internal electrode layer 32 is printed are sequentially laminated thereon, such that a portion functioning as the inner layer portion 11 is formed. A predetermined number of dielectric sheets on which patterns of internal electrode layers are not printed are laminated on a portion functioning as the inner layer portion 11, such that a portion functioning as the second main surface-side outer layer portion 12B adjacent to the second main surface TS2 is formed. Thus, a multilayer sheet is manufactured.

The multilayer sheet is pressed in the lamination direction via a hydrostatic press or the like to form a multilayer block.

By cutting the multilayer block into a predetermined size, the multilayer chip is cut out. At this time, the corner portions and ridge portions of the multilayer chip may be rounded by barrel polishing or the like.

The multilayer chip is fired to form the multilayer body 10. The firing temperature depends on the materials of the dielectric layer 20 and the internal electrode layer 30, but is preferably about 900° C. or higher and about 1400° C. or lower, for example.

An electrically conductive paste functioning as the base electrode layer 50 is applied to both end surfaces of the multilayer body 10. In the present example embodiment, the base electrode layer 50 is a fired layer. An electrically conductive paste including a glass component and a metal is applied to the multilayer body 10 by a method such as dipping. Then, firing treatment is performed to form the base electrode layer 50. The temperature of the firing treatment at this time is preferably about 700° C. or higher and about 950° C. or lower, for example.

In the present example embodiment, the dipping is performed so that the first base electrode layer 50A extends from the first end surface LS1 to a portion of the first main surface TS1 and a portion of the second main surface TS2. Further, the dipping is performed so that the second base electrode layer 50B extends from the second end surface LS2 to a portion of the first main surface TS1 and a portion of the second main surface TS2. At this time, the dipping is preferably performed so that the first base electrode layer 50A extends to a portion of the first lateral surface WS1 and a portion of the second lateral surface WS2. Further, it is preferable that the dipping is performed so that the second base electrode layer 50B extends to a portion of the first lateral surface WS1 and a portion of the second lateral surface WS2.

Here, by adjusting the amount of the binder or the solvent contained in the electrically conductive paste functioning as the base electrode layer 50 and lowering the viscosity of the electrically conductive paste, the thickness of the electrically conductive paste applied to the multilayer body 10 can be reduced. Further, by adjusting the amount of the binder or the solvent contained in the electrically conductive paste, the density of the metal component in the base electrode layer 50 after firing can be adjusted. Thus, the base electrode layer 50 of the present example embodiment can be formed. After the electrically conductive paste is applied to the multilayer body 10, the applied conductive paste is brought into contact with the platen to remove the extra electrically conductive paste, such that the thickness of the electrically conductive paste applied to the end surface LS of the multilayer body 10 can be further reduced.

The multilayer chip before firing and the electrically conductive paste applied to the multilayer chip may be fired simultaneously. In this case, the fired layer is preferably formed by firing a ceramic material added instead of the glass component. At this time, it is particularly preferable to use the same kind of ceramic material as the dielectric layer 20 as the ceramic material to be added. In this case, the electrically conductive paste is applied to the multilayer chip before firing, and the multilayer chip and the electrically conductive paste applied to the multilayer chip are fired at the same time to form the multilayer body 10 in which the fired layer is formed.

Next, the electrically conductive resin layer 60 is formed. The electrically conductive resin layer 60 may be formed on the surface of the base electrode layer 50 or may be formed directly on the multilayer body 10. In the present example embodiment, the electrically conductive resin layer 60 is formed on the surface of the base electrode layer 50.

First, an electrically conductive resin paste in which an electrically conductive filler is dispersed in a thermosetting resin as a base resin functioning as a resin portion is prepared. The electrically conductive resin paste is produced by stirring and mixing the thermosetting resin and the electrically conductive filler. Accordingly, the electrically conductive filler is dispersed and present in a uniform distribution in the electrically conductive resin paste. Here, the thermosetting resin is, for example, an epoxy resin. The electrically conductive filler is, for example, Ag metal powder.

In the present example embodiment, the dipping is performed so that the first electrically conductive resin layer 60A extends from the first end surface LS1 to a portion of the first main surface TS1 and a portion of the second main surface TS2. Further, the dipping is performed so that the second electrically conductive resin layer 60B extends from the second end surface LS2 to a portion of the first main surface TS1 and a portion of the second main surface TS2. At this time, the dipping is preferably performed so that the first electrically conductive resin layer 60A extends to a portion of the first lateral surface WS1 and a portion of the second lateral surface WS2. Further, it is preferable that the dipping is performed so that the second electrically conductive resin layer 60B extends to a portion of the first lateral surface WS1 and a portion of the second lateral surface WS2.

Then, a plated layer 70 is formed on the surface of the electrically conductive resin layer 60. In the present example embodiment, the Ni plated layer 71 and the Sn plated layer 72 are formed on the electrically conductive resin layer 60. The Ni plated layer 71 and the Sn plated layer 72 are sequentially formed by using an electrolytic plating method. As a plating method, for example, barrel plating is preferably used.

The multilayer ceramic capacitor 1 is manufactured by the manufacturing processes described above.

According to the multilayer ceramic capacitor 1 of the present example embodiment, the following advantageous effects can be obtained.

In recent years, ceramic electronic components such as multilayer ceramic capacitors have been used in more severe environments. For example, electronic components used in mobile devices such as mobile phones and portable music players are required to withstand impacts when dropped. Specifically, it is necessary to prevent the electronic component from falling off from the mounting board or to prevent cracks from occurring in the electronic component even when a drop impact is received.

Electronic components for use in vehicle-mounted equipment such as an Electronic Control Unit (ECU) are required to withstand thermal cycling impacts. Specifically, it is necessary to prevent peeling or the like between the resin layer and the base electrode layer from occurring even when a bending stress generated by thermal expansion and contraction of the mounting board due to thermal cycling is received.

On the other hand, in order to reduce the size of the device, a further reduction in the thickness of the external electrode is required. However, in a multilayer ceramic electronic component such as Japanese Unexamined Patent Application Publication No. H11-162771, a technique of reducing the thickness while maintaining bonding properties between a base electrode layer provided on an end surface of a multilayer body and an electrically conductive resin layer is not disclosed.

In an example embodiment of the present invention, in the intermittent region 54 in which the end surface-side base electrode layer 501 is intermittently present while being interrupted, the end surface-side electrically conductive resin layer 601 is in contact with the dielectric layer 20 and the end portion of the internal electrode layer 30 in the interruption region 55 in which the end surface-side base electrode layer 501 is interrupted. Since the end surface-side electrically conductive resin layer 601 is provided inside the interruption region 55 of the end surface-side base electrode layer 501, the reduction in thickness required for forming two layers of the end surface-side base electrode layer 501 and the end surface-side electrically conductive resin layer 601 is achieved without lowering the bonding property. In the present example embodiment, since the electrically conductive filler 62 of the end surface-side electrically conductive resin layer 601 and the end portion of the internal electrode layer 30 are in contact with each other, the electrical connectivity can also be improved.

(1) The multilayer ceramic capacitor 1 (the multilayer ceramic electronic component 1) according to an example embodiment of the present invention includes a multilayer body 10 including a plurality of laminated dielectric layers 20 (the ceramic layers 20), the first main surface TS1 and the second main surface TS2 opposed to each other in the height direction T, the first lateral surface WS1 and the second lateral surface WS2 opposed to each other in the width direction W orthogonal or substantially orthogonal to the height direction T, and the first end surface LS1 and the second end surface LS2 opposed to each other in the length direction L orthogonal or substantially orthogonal to the height direction T and the width direction W, the plurality of internal electrode layers 31 (the first internal conductive layers 31) provided on the plurality of dielectric layers 20 and exposed at the first end surface LS1, the second internal electrode layers 32 (the second internal conductive layers 32) provided on the plurality of dielectric layers 20 and exposed at the second end surface LS2, the first external electrode 40A on the first end surface LS1, and the second external electrode 40B on the second end surface LS2. The multilayer body 10 includes the inner layer portion 11 including the plurality of laminated dielectric layers 20, the plurality of laminated first internal electrode layers 31 and the plurality of laminated second internal electrode layers 32, and the first main surface-side outer layer portion 12A (the first outer layer portion 12A) and the second main surface-side outer layer portion 12B (the second outer layer portion 12B) sandwiching the inner layer portion 11 in the height direction. The first external electrode 40A and the second external electrode 40B each include the end surface-side base electrode layer 501 on the first end surface LS1 and the second end surface LS2, the end surface-side electrically conductive resin layer 601 on the end surface-side base electrode layer 501, and the end surface-side plated layer 701 on the end surface-side electrically conductive resin layer 601. The end surface-side base electrode layer includes the intermittent region 54 in which the end surface-side base electrode layer 501 is intermittently present at least in a region of the inner layer portion 11 in the vicinity of the first main surface-side outer layer portion 12A and a region of the inner layer portion 11 in the vicinity of the second main surface-side outer layer portion 12B, and in the interruption region 55 (the region 55) in which the end surface-side base electrode layer 501 is interrupted, the end surface-side electrically conductive resin layer 601 is in contact with a corresponding one of the plurality of laminated dielectric layers 20 and a corresponding one of the first extension portions 31B (the end portions 31B) of the plurality of laminated first internal electrode layers 31 or the second extension portions 32B (the end portions 32B) of the plurality of laminated second internal electrode layers 32.

With such a configuration, it is possible to provide a multilayer ceramic electronic component that is able to reduce the thickness of the external electrodes 40 while maintaining the bonding property between internal electrode layers 30 and the external electrodes 40.

(2) In the multilayer ceramic capacitor 1 according to the present example embodiment, the end surface-side electrically conductive resin layer 601 includes the electrically conductive filler 62 (the filler 62) of the end surface-side electrically conductive resin layer 601, and the filler 62 is in contact with a corresponding one of the first extension portions 31B of the plurality of laminated first internal electrode layers 31 or the second extension portions 32B of the plurality of laminated second internal electrode layers 32.

With such a configuration, it is possible to maintain the electrical connectivity between the internal electrode layers 30 and the external electrodes 40, and reduce or prevent an increase in ESR.

(3) In the multilayer ceramic capacitor 1 according to the present example embodiment, the end surface-side base electrode layer 501 includes the anchor portion 56, and the anchor portion 56 is provided in a portion adjacent to the interruption region 55 in which the end surface-side base electrode layer 501 is interrupted, and extends in a direction away from one of the first end surface or the second end surface in the length direction and then bends toward the end surface LS, and the end surface-side electrically conductive resin layer 601 includes a portion which is provided between the anchor portion 56 and the end surface LS.

With such a configuration, due to the anchor effect, it is possible to further improve the bonding property between the end surface-side base electrode layer 501 and the end surface-side electrically conductive resin layer 601.

(4) In the multilayer ceramic capacitor 1 according to the present example embodiment, the intermittent region 54 extends from the inner layer portion 11 across the first main surface-side outer layer portion 12A and from the inner layer portion 11 across the second main surface-side outer layer portion 12B, and in the interruption region 55 in which the end surface-side base electrode layer 501 is interrupted, the end surface-side electrically conductive resin layer 601 is in contact with the first main surface-side outer layer portion 12A or the second main surface-side outer layer portion 12B.

With such a configuration, even in a case where bending stress is applied, it is possible to reduce or prevent the generation of cracks in the multilayer body 10. The bending stress concentrates on the corner portions of the multilayer body 10, in addition to the end portions of the external electrode 40 adjacent to the main surface TS. Since the vicinity of the corner portions of the multilayer body 10 and the electrically conductive resin layer are directly bonded to each other, it is possible to reduce or prevent the occurrence of cracks in the multilayer body 10, even when the multilayer body 10 is subjected to bending stress.

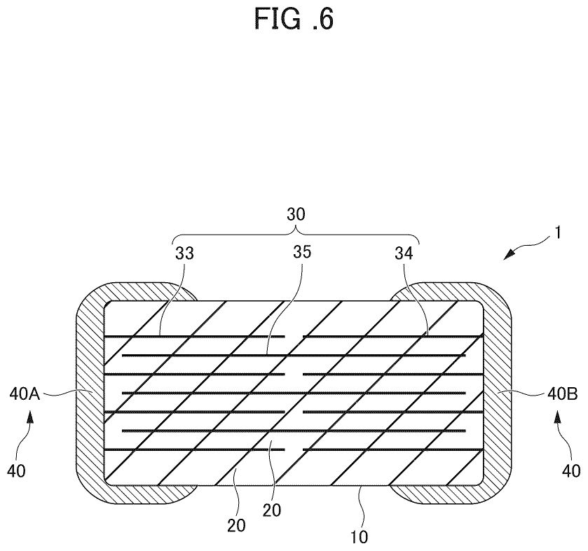

The configuration of the multilayer ceramic capacitor 1 is not limited to the configurations shown in FIGS. 1 to 5. For example, the multilayer ceramic capacitor 1 may be a multilayer ceramic capacitor including a two-portion structure, a three-portion structure, or a four-portion structure as shown in FIGS. 6, 7, and 8.

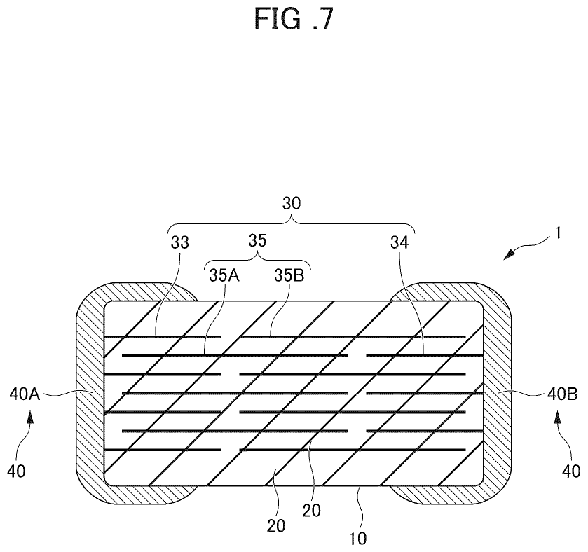

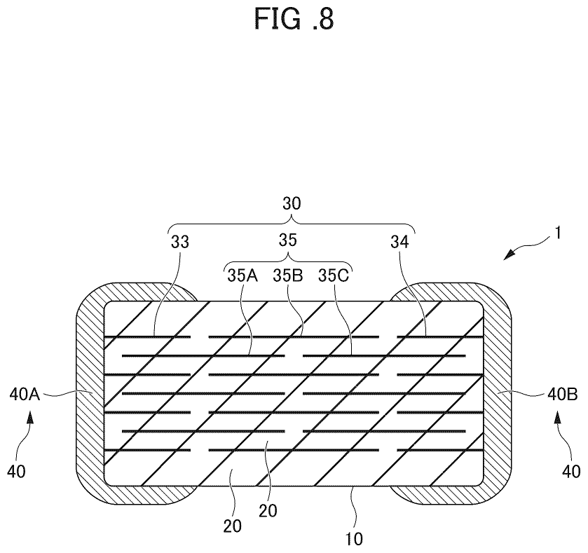

The multilayer ceramic capacitor 1 shown in FIG. 6 is a multilayer ceramic capacitor 1 having a two-portion structure, and includes, as internal electrode layers 30, floating internal electrode layers 35 which are not exposed at either the first end surface LS1 or the second end surface LS2 in addition to the first internal electrode layers 33 and the second internal electrode layers 34. The multilayer ceramic capacitor 1 shown in FIG. 7 is a multilayer ceramic capacitor 1 having a three-portion structure including first floating internal electrode layers 35A and second floating internal electrode layers 35B as floating internal electrode layers 35. The multilayer ceramic capacitor 1 shown in FIG. 8 is a multilayer ceramic capacitor 1 having a four-portion structure including first floating internal electrode layers 35A, second floating internal electrode layers 35B, and third floating internal electrode layers 35C as floating internal electrode layers 35. As described above, by providing the floating internal electrode layers 35 as the internal electrode layers 30, the multilayer ceramic capacitor 1 has a structure in which the counter electrode portions are divided into a plurality of portions. With such a configuration, a plurality of capacitor components are provided between the opposing internal electrode layers 30, and these capacitor components are connected in series. Therefore, the voltages applied to the respective capacitor components are reduced, and thus it is possible to improve the pressure resistance of the multilayer ceramic capacitor 1. In addition, the multilayer ceramic capacitor 1 of the present example embodiment may include a multiple-portion structure of four or more.

The multilayer ceramic capacitor 1 may be of a two-terminal type including two external electrodes or of a multi-terminal type including a large number of external electrodes.

In the above-described example embodiments, as the multilayer ceramic electronic component, a multilayer ceramic capacitor in which the dielectric layers 20 made of dielectric ceramic are used as a ceramic layer is exemplified. However, the multilayer ceramic electronic component according to example embodiments of the present disclosure is not limited thereto. For example, ceramic electronic components according to example embodiments of the present disclosure can be applied to various multilayer ceramic electronic components such as a piezoelectric component using a piezoelectric ceramic as a ceramic layer, a thermistor using a semiconductor ceramic as a ceramic layer, and an inductor using a magnetic ceramic as a ceramic layer. Piezoelectric ceramic includes PZT (lead zirconate titanate) ceramic, semiconductor ceramic includes spinel ceramic, and magnetic ceramic includes ferrite ceramic.

The present invention is not limited to example embodiments of the present invention, and can be appropriately modified and applied without departing from the gist of the present invention. The present invention also includes combinations of two or more of the individual desirable configurations described in the above example embodiments.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic electronic component comprising:
a multilayer body including a plurality of laminated ceramic layers and a plurality of laminated internal conductive layers, a first main surface and a second main surface opposed to each other in a height direction, a first lateral surface and a second lateral surface opposed to each other in a width direction orthogonal or substantially orthogonal to the height direction, and a first end surface and a second end surface opposed to each other in a length direction orthogonal or substantially orthogonal to the height direction and the width direction;
a first external electrode on the first end surface; and
a second external electrode on the second end surface;
the multilayer body including:
an inner layer portion including the plurality of laminated ceramic layers and the plurality of laminated internal conductive layers; and
a first outer layer portion and a second outer layer portion sandwiching the inner layer portion in the height direction; and
the first external electrode and the second external electrode each including:
an end surface-side base electrode layer;
an end surface-side electrically conductive resin layer on the end surface-side base electrode layer; and
an end surface-side plated layer on the end surface-side electrically conductive resin layer; wherein
the end surface-side base electrode layer includes an intermittent region in which the end surface-side base electrode layer is intermittently present at least in a region of the inner layer portion in a vicinity of the first outer layer portion and a region of the inner layer portion in a vicinity of the second outer layer portion; and
in a region in which the end surface-side base electrode layer is interrupted, the end surface-side electrically conductive resin layer is in contact with a corresponding one of the plurality of laminated ceramic layers and a corresponding one of end portions of the plurality of laminated internal conductive layers.

2. The multilayer ceramic electronic component according to claim 1, wherein the end surface-side electrically conductive resin layer includes a filler in contact with a corresponding one of the end portions of the plurality of laminated internal conductive layers.

3. The multilayer ceramic electronic component according to claim 1, wherein
the end surface-side base electrode layer includes an anchor portion located in a portion adjacent to the region in which the end surface-side base electrode layer is interrupted and extending in a direction away from one of the first end surface or the second end surface in the length direction, and bending toward the end surface; and
the end surface-side electrically conductive resin layer includes a portion between the anchor portion and one of the first end surface or the second end surface.

4. The multilayer ceramic electronic component according to claim 1, wherein
the intermittent region extends from the inner layer portion across the first outer layer portion and from the inner layer portion across the second outer layer portion; and
in the region in which the end surface-side base electrode layer is interrupted, the end surface-side electrically conductive resin layer is in contact with the first outer layer portion or the second outer layer portion.

5. The multilayer ceramic electronic component according to claim 1, wherein the multilayer body has a substantially rectangular parallelepiped shape.

6. The multilayer ceramic electronic component according to claim 1, wherein the multilayer body includes rounded rides and corner portions.

7. The multilayer ceramic electronic component according to claim 1, wherein each of the plurality of ceramic layers is made of a dielectric material.

8. The multilayer ceramic electronic component according to claim 1, wherein the end surface-side plated layer of each of the first and second external electrodes includes a Ni plated layer and an Sn plated layer.

9. The multilayer ceramic electronic component according to claim 1, wherein a configuration of layers of the first external electrode and the second external electrode are the same or substantially the same.

10. The multilayer ceramic electronic component according to claim 1, wherein the first external electrode and the second external electrode are substantially plane symmetrical with respect to a length-width cross section in a middle of the length direction of the multilayer body.

11. The multilayer ceramic electronic component according to claim 1, wherein the end surface-side base electrode layer of each of the first and second external electrode is a fired layer.

12. The multilayer ceramic electronic component according to claim 11, wherein the fired layer includes a metal component and either or both of a glass component and a ceramic component.

13. The multilayer ceramic electronic component according to claim 1, wherein a thickness in the length direction of the end surface-side base electrode layer of each of the first and second external electrode is about 2 μm or more and about 220 μm or less in a middle portion in the lamination direction and the width direction.

14. The multilayer ceramic electronic component according to claim 1, wherein a thickness in the length direction of the end surface-side base electrode layer of each of the first and second external electrode is about 10 μm or more and about 45 μm or less in a middle portion in the lamination direction and the width direction.

15. The multilayer ceramic electronic component according to claim 1, wherein a thickness in the length direction of the end surface-side electrically conductive resin layer of each of the first and second external electrodes is about 10 μm or more and about 200 μm or less in a middle portion in the lamination direction and the width direction.

16. The multilayer ceramic electronic component according to claim 1, wherein the intermittent region includes a plurality of interruption regions in which an end surface is exposed at the end surface-side electrically conductive resin layer.

17. The multilayer ceramic electronic component according to claim 16, wherein a ratio of the presence of the interruption regions increases toward the first or second outer layer portions.

18. The multilayer ceramic electronic component according to claim 1, wherein the intermittent region is not provided in a middle region in the height direction of the inner layer portion.

19. The multilayer ceramic electronic component according to claim 1, wherein the region of the inner layer portion in the vicinity of the first outer layer portion and the region of the inner layer portion in the vicinity of the second outer layer portion range from a boundary between the inner layer portion and the outer layer portion to a position at about 5% of a dimension of the inner layer portion in the lamination direction toward a middle of the inner layer portion in the height direction.

20. The multilayer ceramic electronic component according to claim 3, wherein the anchor portion includes an undercut portion.
